(19) United States
(12) Patent Application Publication
(10) Pub. No.: US 2019/0373800 A1
(43) Pub. Date: Dec. 12, 2019

(54) HOE DRILL OPENER

(71) Applicant: Tyler Smith, Oakley, KS (US)

(72) Inventor: Tyler Smith, Oakley, KS (US)

(21) Appl. No.: 16/003,093

(22) Filed: Jun. 7, 2018

(51) Int. Cl. A01C 5/06

(52) U.S. Cl. CPC A01C 5/064; A01C 5/068

(57) ABSTRACT

A hoe drill opener including: a hydraulic cylinder; a frame mount attached on a first end of the hydraulic cylinder, where the frame mount is adapted to adjoin to a tractor; a pressure adjuster attached to the hydraulic cylinder at a second end; a depth adjuster extending from the pressure adjuster; a tiller at a first end of the depth adjuster; an opener extending from the depth adjuster, where the opener is adapted for sowing; and a wheel brace attached to the depth adjuster where the wheel brace support a wheel. Notches may also be provided on the pressure adjuster to allow adjustment of the tiller and opener. Preferably, depth is adjusted through the depth adjuster in conjunction with the pressure adjuster.

### BACKGROUND OF THE INVENTION

### Field of Invention

The present invention relates to a hoe drill opener that performs three aspects of farming.

### Description of Related Art

The basic aspects of farming involve tilling, sowing, and packing to ensure the growth of a particular plant. Normally farmers till farmland in a series of rows then sow seeds onto the rows and then pack seeds for growth purposes. These processes are normally separated or at least use two different types of tooling to perform the required functions. Initially farmers or gardeners must till the soil, which is the process of turning over and breaking up the soil in order to add fertilizer and seeds into the soil. After tilling is completed sowing takes place where seeds are planted and placed in the ground at appropriate depth. Then after sowing the seeds might be packed into the soil to ensure proper growth. It would be advantageous to have a tool which could be used to perform all three processes with the proper attachment to the tractor.

### SUMMARY OF THE INVENTION

The present invention relates to a hoe drill opener including: a hydraulic cylinder; a frame mount attached on a first end of the hydraulic cylinder, where the frame mount is adapted to adjoin to a tractor; a pressure adjuster attached to the hydraulic cylinder at a second end; a depth adjuster extending from the pressure adjuster; a tiller at a first end of the depth adjuster; an opener extending from the depth adjuster, where the opener is adapted for sowing; and a wheel brace attached to the depth adjuster where the wheel brace support a wheel. Notches may also be provided on the pressure adjuster to allow adjustment of the tiller and opener. Preferably, depth is adjusted through the depth adjuster in conjunction with the pressure adjuster.

### BRIEF DESCRIPTION OF DRAWINGS

FIG. 1 depicts a hoe drill opener in accordance with the present invention.

### DETAILED DESCRIPTION

The present invention relates to a hoe drill opener that includes a tilling tool combined with a sowing apparatus and a packing wheel, which follows these two tools when attached to a tractor. The present invention advantageously provides a complete farming tool that has adjustment settings to vary the depth of sowing and a compacting wheel to compact the seeds as they are placed through the sowing tool.

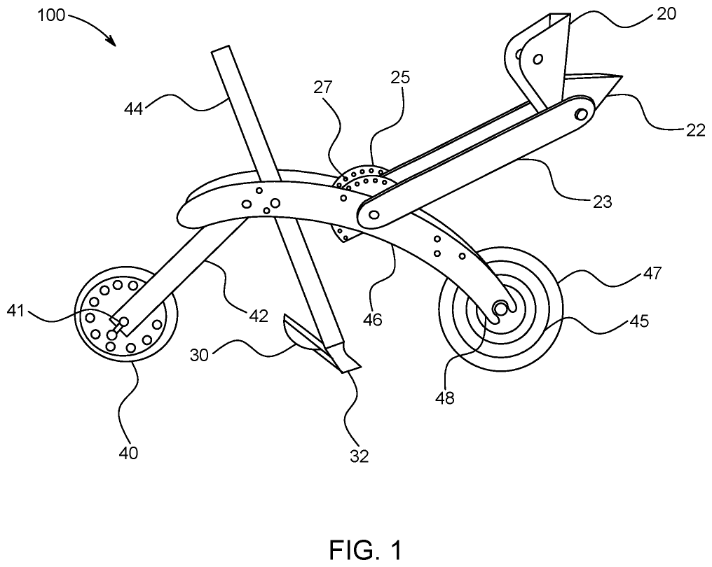

In reference to FIG. 1 a Hoe Drill Opener 100 is depicted. The Hoe Drill Opener 100 includes a Frame Mount 20 that mounts onto a tractor with an adjoining Part 22. This frame mount 20 allows the Drill Opener 100 to be mounted properly on a tractor. Three tools are provided on this Drill Opener 100. Initially, a Hydraulic Cylinder 23 is connected to a Pressure Adjuster 25. The Pressure Adjuster 25 allows movement and adjustment of a Depth Adjuster 46 that includes Tiller 48 at the distal end thereof. The Tiller 48 is followed by an Opener 44 where the Opener 44 operates as a sowing tool. The Depth Adjuster 46 includes a distal end and a proximal end and is connected to the frame of the Depth Adjuster 46. At the distal end of the Depth Adjuster 46 is a Coulter 47 and Depth Adjuster 45 attached to an Axial 48. Notches 27 are provided on the Pressure Adjuster 25 to allow adjustment of the Tiller 46 with the Opener 44 following thereof. At the distal end of the Opener 44 is a Seed Tube 30 and an Opener Point 32, where seeds are distributed through the Opener Point 32 from Seed Tube 30. At the proximal end of the Depth Adjuster 46 is a Wheel Base 42. Attached to the Wheel Base 42 is Wheel 40 attached to the Wheel Base 42 through the Axle 41. The Wheel 40 functions as a packing tool to pack soil after the sowing has been performed by Opener 44. Again the depth is adjusted through the Depth Adjuster 46 and Pressure Adjuster 45. Overall, the present invention therefore provides a convenient and efficient tool that takes care of the complete sowing process from tilling to packing in now one convenient tool. Further the adjustability allows for depth to be adjusted as needed on the tool.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A hoe drill opener comprising:
a. a hydraulic cylinder;
b. a frame mount attached on a first end of the hydraulic cylinder, where the frame mount is adapted to adjoin to a tractor;
c. a pressure adjuster attached to the hydraulic cylinder at a second end;
d. a depth adjuster extending from the pressure adjuster;
e. a tiller at a first end of the depth adjuster;
f. an opener extending from the depth adjuster, where the opener is adapted for sowing; and
g. a wheel brace attached to the depth adjuster where the wheel brace support a wheel.

2. The hoe drill opener according to claim 1, further including notches 27 on the pressure adjuster to allow adjustment of the tiller and opener.

3. The hoe drill opener according to claim 1, where depth is adjusted through the depth adjuster in conjunction with the pressure adjuster.
